(19) United States
(12) Patent Application Publication
(10) Pub. No.: US 2009/0074279 A1
(43) Pub. Date: Mar. 19, 2009

(54) METHOD AND SYSTEM OF MULTIVARIATE ANALYSIS ON SLICE-WISE DATA OF REFERENCE STRUCTURE NORMALIZED IMAGES FOR IMPROVED QUALITY IN POSITRON EMISSION TOMOGRAPHY STUDIES

(76) Inventors: Pasha Razifar, Uppsala (SE); Mats Bergstrom, London (GB); Bengt Langstrom, Uppsala (SE); Gunnar Blomqvist, Uppsala (SE); Henry Engler, Uppsala (SE)

Correspondence Address: GE HEALTHCARE, INC., IP DEPARTMENT, 101 CARNEGIE CENTER, PRINCETON, NJ, 08540-6231, US

(21) Appl. No.: 12/065,111

(22) PCT Filed: Aug. 31, 2006
(86) PCT No.: PCT/IB2006/002394

§ 371 Date: Oct. 29, 2008

Related U.S. Application Data
(60) Provisional application No. 60/712,780, filed on Aug. 31, 2005.

(51) Int. Cl. G06K 9/00

(52) U.S. Cl. 382/131

(57) ABSTRACT

A method and system are provided for improving the quality in positron emission tomography (PET) images. Image quality may be improved by pre-normalizing dynamic PET images and then applying a multivariate analysis tool on the images to generate improved quality dynamic PET images. The dynamic PET images are the images reconstructed from the raw dynamic PET data in the image domain of the PET study. A first normalization method is a data treatment (also referred to as noise pre-normalization) for the negative values that may result from the image reconstruction and/or from random variations in detector readings. A second normalization method is background noise pre-normalization where background pixel values are masked. A third normalization method is kinetic pre-normalization where the contrast is improved to allow greater visualization of the activity in the image. Multivariate analysis such as PCA may then be applied to each slice of the dynamic PET images.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates to a method and system of multivariate analysis of reference structure normalized images for improved quality in positron emission tomography (PET) studies. One embodiment of the present invention relates to the use of principal component analysis (PCA) as the multivariate analysis tool. This embodiment further relates to the application of PCA on slice-wise dynamic PET images which may use pre-PCA normalization techniques to reduce or factor out random noise, background noise, and/or to enhance contrast.

### BACKGROUND

Positron Emission Tomography (PET) is an available specialized imaging technique that uses tomography to computer-generate a three-dimensional image or map of a functional process in the body as a result of detecting gamma rays when artificially introduced radionuclides incorporated into biochemical substances decay and release positrons. Analysis of the photons detected from the deterioration of these positrons is used to generate the tomographic images which may be quantified using a color scale to show the diffusion of the biochemical substances in the tissue indicating localization of metabolic and/or physiological processes. For example, radionuclides used in PET may be a short-lived radioactive isotope such as Flourine-18, Oxygen-15, Nitrogen-13, and Carbon-11 (with half-lives ranging from 110 minutes to 20 minutes). The radionuclides may be incorporated into biochemical substances such as compounds normally used by the body that may include, for example, sugars, water, and/or ammonia. The biochemical substances may then be injected or inhaled into the body (e.g., into the blood stream) where the substance (e.g., a sugar) becomes concentrated in the tissue of interest where the radionuclides begin to decay emitting a positron. The positron collides with an electron producing gamma ray photons which can be detected and recorded indicating where the radionuclide was taken up into the body. This set of data may be used to explore and depict anatomical, physiological, and metabolic information in the human body. While alternative scanning methods such as Magnetic Resonance Imaging (MRI), Functional Magnetic Resonance Imaging (fMRI), Computed Tomography (CT), and Single Photon Emission Computed Tomography (SPECT) may be used to isolate anatomic changes in the body, PET may use administrated radiolabeled molecules to detect molecular detail even prior to anatomic change.

PET studies in humans are typically performed in either one of two modes, providing different sets of data: whole body acquisition whereby static data for one body sector at a time is sequentially recorded and dynamic acquisition whereby the same sector is sequentially imaged at different time points or frames. Dynamic PET studies collect and generate data sets in the form of congruent images obtained from the same sector. These sequential images can be regarded as multivariate images from which physiological, biochemical and functional information can be derived by analyzing the distribution and kinetics of administrated radiolabeled molecules. Each one of the images in the sequence displays/contains part of the kinetic information.

Due to limitations in the amount of radioactivity administered to the subject, a usually short half-life of the radionuclide and limited sensitivity of the recording system, dynamic PET images are typically characterized by a rather high level of noise. This together with a high level of non-specific binding to the target and sometimes small differences in target expression between healthy and pathological areas are factors which make the analysis of dynamic PET images difficult independent of the utilized radionuclide or type of experiment. This means that the individual images are not optimal for the analysis and visualization of anatomy and pathology. One of the standard methods used for the reduction of the noise and quantitative estimation in dynamic PET images is to take the sum, average, or mean of the images of the whole sequence or part of the sequence where the specific signal is proportionally larger. However, though sum, average, or mean images may be effective in reducing noise, these approaches result in the dampening of the differences detected between regions with different kinetic behavior.

Another method used for analysis of dynamic PET images is kinetic modeling with the generation of parametric images, aiming to extract areas with specific kinetic properties that can enhance the discrimination between normal and pathologic regions. One of the well established kinetic modeling methods used for parameter estimation is known as the Patlak method (or sometimes Gjedde method). The ratio of target region to reference radioactivity concentration is plotted against a modified time, obtained as the time integral of the reference radioactivity concentration up to the selected time divided by the radioactivity concentration at this time. In cases where the tracer accumulation can be described as irreversible, the Patlak graphical representation of tracer kinetics becomes a straight line with a slope proportional to the accumulation rate. This method can readily be applied to each pixel separately in a dynamic imaging sequence and allows the generation of parametric images representative of the accumulation rate. Alternative methods for the generation of parametric images exist; based on other types of modeling, e.g. Logan plots, compartment modeling, or extraction of components such as in factor analysis or spectral analysis. Other alternatives such as population approaches, where an iterative two stage (ITS) method is utilized, have been proposed and studied and are available.

A notable problem when using kinetic modeling is that the generated parametric images suffer from poor quality while the images are rather noisy. This indicates that kinetic modeling methods such as Reference Patlak, do not consider any Signal-to-Noise-Ratio (SNR) optimization during the measurement of physiological parameters from dynamic data.

Dynamic PET images can also be analyzed utilizing different multivariate, statistical techniques such as Principal Component Analysis (PCA), which is one of the most commonly used multivariate analysis tools. PCA also has several other applications in the medical imaging field such as, for example, in Computed Tomography (CT) and in functional Magnetic Resonance Imaging (fMRI). This technique is employed in order to find variance-covariance structures of the input data in unison to reduce the dimensionality of the data set. The results of the PCA can further be used for different purposes e.g. factor analysis, regression analysis, and used for performing preprocessing of the input/raw data.

The conventional use of PCA indicates a data driven technique which has difficulty in separating the signal from the noise when the magnitude of the noise is relatively high. The presence of variable noise levels in the different dynamic PET images dramatically affects the subsequent multivariate analysis unless properly handled otherwise PCA will emphasize noise and not the regions with different kinetics. For this reason, using PCA on dynamic PET images is not an optimal solution.

### BRIEF DESCRIPTION OF THE DRAWINGS

FIG. 1 is a flowchart illustrating one method or process for improving dynamic PET image quality according to one embodiment of the present invention.

FIG. 2 is an illustration of an outlined masked area on the background of a dynamic PET image according to one embodiment of the present invention.

FIG. 3 is a selection of the resulting images obtained by applying the Reference Patlak method on dynamic PET images taken from a patient with Alzheimer's disease (AD).

FIG. 4 is a selection of the resulting images obtained by applying the reference Patlak method on dynamic PET images taken from a healthy volunteer.

FIG. 5 is a selection of the resulting images obtained by applying the summation of the images through all the frames (i.e., summing each slice for all the frames) for the same Alzheimer's disease (AD) patient.

FIG. 6 is a selection of the resulting images obtained by applying the summation of the images through all the frames for the same healthy volunteer.

FIG. 7 is a selection of the first principal component results (i.e., the PC1 images) of applying PCA on the pre-normalized dynamic PET images for the same Alzheimer's disease (AD) patient according to one embodiment of the present invention.

FIG. 8 is a selection of the second principal component results (i.e., the PC2 images) of applying PCA on the pre-normalized dynamic PET images for the same Alzheimer's disease (AD) patient according to one embodiment of the present invention.

FIG. 9 is a selection of the first principal component results (i.e., the PC1 images) of applying PCA on the pre-normalized dynamic PET images for the same healthy volunteer according to one embodiment of the present invention.

FIG. 10 is a selection of the second principal component results (i.e., the PC2 images) of applying PCA on the pre-normalized dynamic PET images for the same healthy volunteer according to one embodiment of the present invention.

FIG. 11 is a comparison between the slice 28 images obtained for the same Alzheimer's disease (AD) patient using the reference Patlak method, the summation method, and PCA on pre-normalized dynamic PET images according to one embodiment of the present invention.

FIG. 12 is a comparison between the slice 39 images obtained for the same healthy volunteer using the reference Patlak method, the summation method, and PCA on pre-normalized dynamic PET images according to one embodiment of the present invention.

FIG. 13 is a block diagram illustrating the platform on which the dynamic PET image pre-normalization and PCA analysis may operate according to one embodiment of the present invention.

### DETAILED DESCRIPTION

In one embodiment of the present invention, these limitations are at least partially overcome by a method and system of using one or more normalization methods for reducing the impact of noise in the dynamic positron emission tomography (PET) images/data followed by applying multivariate image analysis such as principal component analysis (PCA) in order to improve discrimination between affected and unaffected regions in the brain and improving the quality of the dynamic PET images and diagnosis in the PET studies. The dynamic PET images (also referred to herein as reconstructed dynamic PET data or reconstructed PET data) are the images reconstructed from the raw dynamic PET data in the image domain of the PET study. A first normalization method for the dynamic PET images according to one embodiment of the present invention is data treatment (also referred to herein as noise pre-normalization) for the negative values that may result from the image reconstruction and/or from random variations in detector readings. A second normalization method for the dynamic PET images according to one embodiment is a background noise pre-normalization where the background pixel values are masked and used to correct for background noise in the image. A third normalization method according to one embodiment is a kinetic pre-normalization (i.e., a contrast enhancement procedure) where the contrast between affected and unaffected regions within an image is improved to allow greater visualization of the activity in the image. This normalization of the dynamic PET images is termed pre-normalization herein because it occurs prior to the main processing which in this case is the multivariate analysis (e.g., PCA). In alternative embodiments of the present invention, the preceding pre-normalization methods may either all be performed, some of the methods performed in any combination, or none of the pre-normalization methods may be used. In one example embodiment of the present invention, all three pre-normalization methods are applied. Multivariate analysis using a tool such as PCA may be applied according to one embodiment of the present invention on the pre-normalized (if any pre-normalization has occurred) dynamic PET images. The PCA may be performed for each slice of dynamic PET images and is referred to herein as Slice-Wise application of PCA (SW-PCA).

According to one embodiment of the present invention, data enhancement techniques (e.g., noise pre-normalization, background noise pre-normalization, and kinetic pre-normalization) and multivariate analysis may be used on the dynamic PET images to enhance the quality of the PET study on a biological and/or anatomical region or process in the body (such as for example in the human brain). Even though this embodiment is discussed in relation to using conventional tracers (administrated radiolabeled molecules) in different clinical applications on the human brain, other embodiments of the present invention may be applied to other biological or anatomical regions and/or processes in a human or other body or in other PET applications. The data enhancement techniques discussed herein may be used individually or in combination with each other and in conjunction with multivariate analysis (such as for example principal component analysis—PCA). The embodiments discussed herein refer to principal component analysis (PCA) as the multivariate analysis tool though other tools such as independent component analysis (ICA) may alternatively be used.

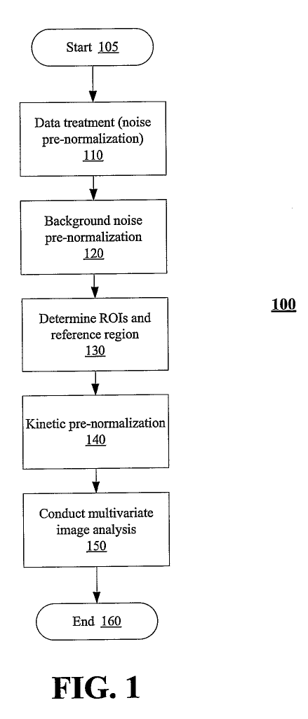

FIG. 1 is a flowchart illustrating one method or process for improving dynamic PET image quality according to one embodiment of the present invention. The process 100 begins 105 by performing a data treatment technique (noise pre-normalization) 110 correcting for or factoring out random noise in the dynamic PET images. Data treatment (noise pre-normalization) 110 may be followed by background noise pre-normalization 120. Background noise pre-normalization 120 may involve estimating the standard deviation of the noise in the background area of the image (i.e., the masked area outside of the object being studied such as, for example, the brain). The background area may be determined by applying a mask to the image as discussed later herein. This background noise pre-normalization may be performed separately for each slice and frame with the PET input data adjusted accordingly. After background noise pre-normalization 120, a Region of Interest (ROI) is drawn for a reference region 130. Kinetic pre-normalization 140 (which may also be referred to herein as biological pre-normalization or contrast enhancement) may then be performed. Kinetic pre-normalization 140 involves taking all the slices (i.e. images taken from different perspectives and/or covering different biological or anatomical areas or planes) for each frame (i.e., period of time or snapshot in time) and dividing by the mean value within the selected ROI(s) representing the reference region within the frame in order to enhance the contrast and margin between affected and unaffected regions within the images. These pre-normalization methods 120, 130, 140 allow for the enhanced performance of a multivariate image analysis tool 150, such as PCA, on the dynamic PET images before the process ends 160. The simplified flowchart shown in FIG. 1 outlines only one method or process for improving dynamic PET image quality according to one embodiment of the present invention. This overall process and the associated pre-normalization methods are discussed in greater detail below.

Dynamic PET image data may contain a high magnitude of noise and correlation between the pixels. Raw dynamic PET data generated for the slices and frames of PET study may be reconstructed analytically into reconstructed dynamic PET data or dynamic PET images by using, for example, a Filtered Back Projection (FBP) method or iteratively by using an Ordered Subsets Expectation Maximization (OSEM) method. Regardless of the reconstruction methodology used, the resulting images may contain effects and/or errors due to the algorithms and corrections used which may in turn affect PCA performance. For example, the reconstruction may result in a strong correlation between pixels. In order to reduce these conditions and improve the results of multivariate analysis (i.e., PCA) on the dynamic PET image data, data treatment and/or other pre-normalization may first be performed according to one embodiment of the present invention. These initial normalization methods are applied before the main algorithm (in this case the multivariate analysis-PCA) hence they are termed pre-normalization.

The first step 110 in the process 100 is data treatment or noise pre-normalization as previously discussed. The data treatment or noise pre-normalization primarily refers to a method of reducing or factoring out (i.e., correcting for) random negative pixel values within the image according to this embodiment. For example, dynamic PET images reconstructed using a Filtered Back-Projection (FBP) technique may contain random negative pixel values within the image that are independent of other planes (i.e., slices) or frames. These negative pixel values may result from a combination of random variations in the detector readings along with the application of FBP. These negative pixel values in the image may be considered to contain “noise”.

According to one embodiment of the present invention, data treatment is performed on each of these random negative pixel values. For example, the data treatment may include replacing the negative pixel value with the square root of the absolute value of the negative pixel. In other words, given an input matrix Xᵢₘ=[Xᵢ₁, Xᵢ₂, Xᵢ₃, . . . , Xᵢₘ] where Xᵢₖ is a column vector containing i=1 . . . n number of dynamic PET images (e.g., 63) of size 128*128 pixels, m is the total number of frames and k=1 . . . m, then: j represents a pixel ranging from 1 . . . 128*128 in each image (column vector) for each frame, and (Xᵢₘ)_{T}=[Xᵢ₁, Xᵢ₂, Xᵢ₃, . . . , Xᵢₘ]_{T}, (Xᵢⱼ)_{T} is the new column vector in the new matrix of the same size as the input data, the value of pixel j in the single image i containing the negative value Xᵢⱼ is given a new value (Xᵢⱼ)_{new} applying the equation (Xᵢⱼ)_{new}=sqrt(abs(Xᵢⱼ)) for the data treatment according to one embodiment of the present invention. This new matrix may then serve as the input data for the following step in the SW-PCA process according to this embodiment. As previously stated, the data treatment to correct for random negative pixel values may be termed noise pre-normalization because it brings this noise (i.e., the random negative pixels values) into a normal or corrected state and it does this before performing the main processing which is the multivariate analysis on the dynamic PET images.

In addition to the noise pre-normalization (i.e., the data treatment) discussed above, the reduction of other background noise may also improve the performance of the multivariate analysis tool and hence the quality of the dynamic PET image according to one embodiment of the present invention. Background noise pre-normalization (also referred to herein as “nor1” pre-normalization) is the second step 120 in this process 100. According to one embodiment, each pixel value j in an image i may be divided by the standard deviation sᵢ of the noise calculated from an outlined masked area in the background of the image represented by a vector containing these masked background pixel values in order to normalize the pixel values to factor out or reduce the background noise in the image. This may be shown in the equation below where xᵢⱼ refers to the original value of the pixel j of image i and Xᵢⱼ refers to the resulting new value for the pixel.

Xᵢⱼ=xᵢⱼ/sᵢ

This equation may be applied to all the pixels in an image according to this embodiment of the present invention. Pixels with a value of zero will of course retain their zero value even if this equation is applied and, therefore, this equation may be selectively applied to pixels containing a non-zero value in an alternative embodiment.

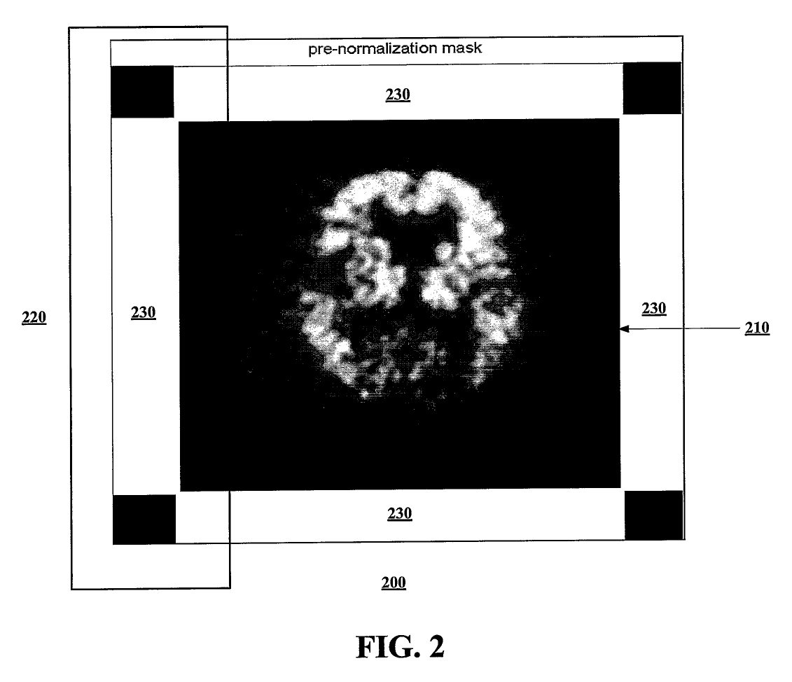

FIG. 2 is an illustration of an outlined masked area on the background of a dynamic PET image according to one embodiment of the present invention. The dynamic PET image 200 contains an object being studied (i.e., the brain) 210. Outside of the object 210 is the background area 220 of the dynamic PET image 200. A mask 230 may be used to cover pixels containing noise from different angles in the background within the image 200 in order to obtain better estimation of the magnitude of noise as defined by its standard deviation. The mask may automatically be determined using an algorithm or rules-based system operating on certain input parameters. In a dynamic PET image 200 reconstructed using for example FBP, some of the background pixels outside the object 210 (which, for example, may be identified by a circular area containing the main object studied) may have a zero value. These zero value background pixels can impact the estimate of standard deviation for the background pixels within the image if they are included in the vector used for background noise pre-normalization, even though the magnitude of this error should be the same for all frames. In one embodiment of the present invention, this error may be reduced or corrected by determining this outlined masked area 230 and by not including the zero value background pixels found within this outlined masked area 230 in the vector used for background noise pre-normalization.

A third step 130 in the process 100 is to identify at least one region of interest (ROI) for the whole brain (i.e., object under study) (which may include a reference region that is devoid of specific binding such as, for example, the cerebellum) and then to use the ROI(s) in a fourth step 140 to improve the contrast between affected and unaffected regions in the image according to this embodiment. The contrast of a dynamic PET image may be improved thereby allowing a greater visualization of the activity in the dynamic PET image according to one embodiment of the present invention. According to this embodiment, kinetic pre-normalization (i.e., contrast enhancement) may be performed using ROI(s) representing the reference region in order to improve the contrast within the dynamic PET image (also referred to herein as “mixp” pre-normalization). The reference region may be determined 130 by outlining the regions-of-interest (ROI) for a region devoid of specific binding and representative of the free tracer fraction in the target tissue for the biological or anatomical area being studied (such as, for example, a cerebellar cortex). ROI representing the reference region can be outlined on images obtained from either applying PCA on non-pre-normalized images or, for example, using sum images. In other words, principal component analysis (PCA) may be performed on the frames for a PET study without first performing any data treatment (i.e., noise pre-normalization) or background noise pre-normalization. This may result in a first principal component for a single frame containing a corresponding number of planes/slices (e.g., 63) with improved contrast (for example, particularly between the white and gray matter in a cerebellar cortex) allowing greater visualization of the biological or anatomical area being studied and displaying an improved signal-to-noise ration (SNR). The reference region may then be determined from the ROI(s) identified through this process in one embodiment of the present invention. Other alternative embodiments may determine the reference region differently (for example, using sum images).

Kinetic pre-normalization according to this embodiment is based on outlining ROI(s), calculating the mean value for the pixels included in the ROI(s), and dividing all the pixels in the images (slices) for each frame by this mean value. For example, if there are 12 frames containing 63 images (slices) each then 12 different mean values (one for each frame) will be generated and all pixels values for the 63 images (63×128×128 pixels within the frame) are divided by the corresponding mean value. In an alternative embodiment, zero value pixels may not be divided by the mean value. The ROI(s) may be manually drawn (determined) in one embodiment while alternatively automated or semi-automated methods may also be used.

Kinetic pre-normalization according to one embodiment of the present invention is performed by dividing the value of each pixel j in a single image i by the mean value x̅ᵢ̅ of the pixels within the reference region as determined by the ROI(s) as discussed above. This kinetic pre-normalization equation according to this embodiment is shown below.

$${X}_{ij} = \frac{{X}_{ij}}{{\overline{x}}_{i}}$$

Kinetic pre-normalization improves the contrast between different regions in the dynamic PET images by reducing the pixel values according the kinetic behavior of the reference region. The data treatment 110, background noise pre-normalization 120, determining the ROI(s) and the reference region 130, and kinetic pre-normalization 140 are preparatory pre-normalization steps for the multivariate analysis tool (e.g., PCA) in one embodiment of the SW-PCA method.

PCA is a well-established technique based on exploring the variance-covariance or correlation structure between the input data represented in different Principal Components (PCs). PCA is based on the transformation of the original data in order to reduce the dimensionality by calculating transformation vectors (PCs), which define the directions of maximum variance of the data in the multidimensional feature space. Each PC is orthogonal to all the others meaning that the first PC (e.g., PC1) represents the linear combination of the original variables containing the maximum variance, the second PC (e.g., PC2) is the combination containing as much of the remaining variance as possible orthogonal to the previous PC (e.g., PC1) and so on. The term “PC images” corresponds to “Score images” and are used in conjunction with performing back projection of data and visualization of the PC vectors as images.

The PCA step 150 can be described in general as follows. The input data used in the slice-wise application of PCA (SW-PCA) may be represented in a matrix X′ composed of column vectors Xᵢ that contain the pixel data (e.g., the data representing the brain) for the different frames 1 to i. This matrix may be represented as follows:

X′=└X₁, X₂, X₃, . . . , Xₚ┘

where the matrix X′ has an associated variance-covariance matrix S with eigenvalues λ=└λ₁, λ₂, λ₃, . . . , λₚ┘ and corresponding eigenvectors e=└e₁, e₂, e₃, . . . , eₚ┘ where λ₁≧λ₂≧λ₃≧ . . . ≧λₚ≧0 and p corresponds to the number of the input column in the matrix X′. The q^{th} principal component (PCq) may then be generated using the following equation where q=p:

Y_{q}=e′X=e_{q1}X₁+e_{q2}X₂+e_{q3}X₃+ . . . +e_{qp}Xₚ

PCA using this equation requires uncorrelated components meaning that the condition Cov(Y_{q},Yᵢ)=0 where i≠q is necessary. In addition, each PC is orthogonal to all other PCs meaning that the first PC (e.g., PC1) represents the linear combination of the original variables (i.e., the masked input data) which contain (i.e., explains) the greatest amount of variance (maximum variance). The second PC (e.g., PC2) represents the combination of variables containing as much of the remaining variance as possible (i.e., defining the next largest amount of variance) orthogonal to the first PC (i.e., independent of the first principal component) and so on for the following PCs. Each PC explains the magnitude of variance in decreasing order. This description of PCA is for one embodiment of the present invention and is included as a representative example of PCA. In other embodiments of the present invention, PCA may be performed differently and/or by using different equations other than those described herein.

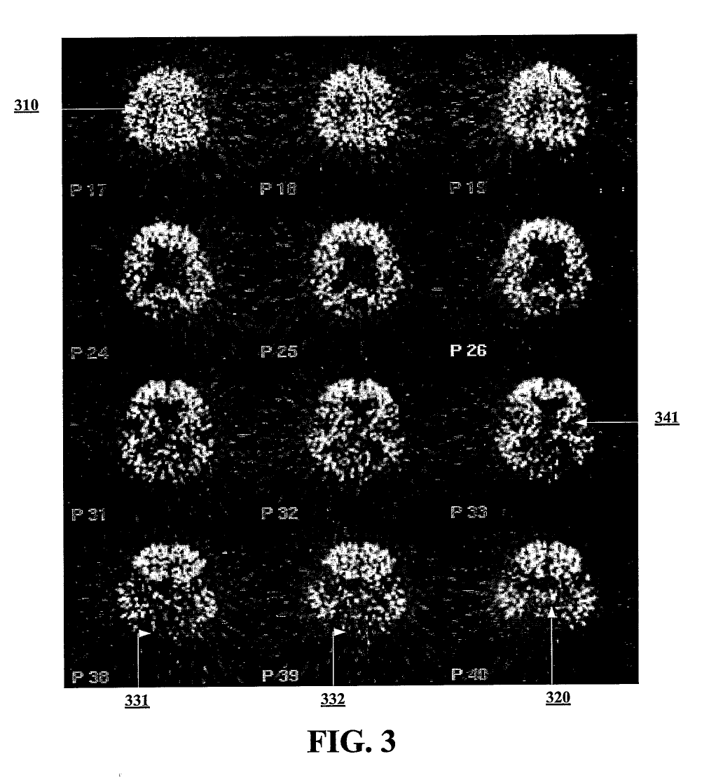

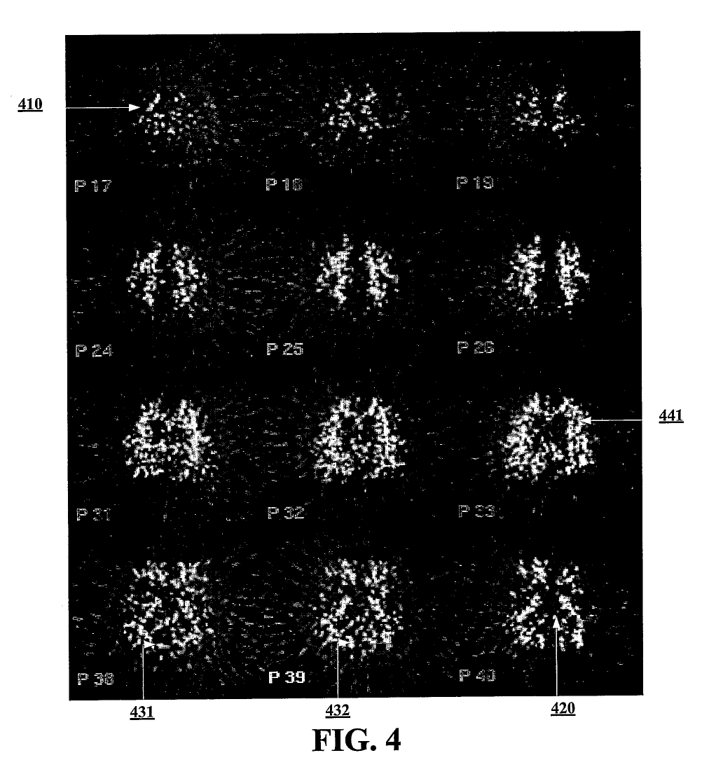

FIG. 3 is a selection of the resulting images obtained by applying the Reference Patlak method on dynamic PET images taken from a patient with Alzheimer's disease (AD). FIGS. 3-12 involve a PET study using the amyloid imaging agent N-methyl-[¹¹C]2-(4′-methylaminophenyl)-6-hydroxybenzothiazole (PIB) performed in healthy volunteers and patients with suspected Alzheimer's disease. Dynamic PET data was acquired applying the 3D mode using two Siemens ECAT HR+ cameras providing 63 contiguous slices. The dynamic PET images later were reconstructed using Filtered Back-Projection (FBP), based on applying Fourier Rebinning on input data followed by two-dimensional filtered back-projection with applied 4 mm Hanning filter. This reconstruction procedure was performed using the standard software included with the scanner. FIG. 3 shows several images each representing one slice (plane) of the PET study. For example, plane 17 (slice 17) 310 and plane 40 (slice 40) 320 are two of the slices shown. The results of the pixel-by-pixel application of the reference Patlak method shown in FIG. 3, demonstrate a high accumulation in the cortex of the Alzheimer's disease patient, especially the frontal cortex, and the low accumulation in the cerebellum. High accumulation is equal to a high pixel value closer to the white and low accumulation is equal to low pixel value closer to black where, for example, a Sokolof color table is used. FIG. 4 is a selection of the resulting images obtained by applying the reference Patlak method on dynamic PET images taken from a healthy volunteer. FIG. 4 shows the low binding in the cortex of the healthy volunteer. In particular differences in the accumulation (i.e., differences in the kinetic activity) are shown, for example, in two particular locations in FIG. 3 in slice 38 331 and in slice 39 332 compared to similar locations in FIG. 4 in slice 38 431 and in slice 39 432. Even though there is a lot of noise, the contrast between the AD patient and the healthy volunteer is evident, for example shown by comparing slice 33 341, 441 in both FIGS. 3 and 4. Even though the accumulation may be seen in the images, the images for the slices in FIGS. 3 and 4 contain considerable noise.

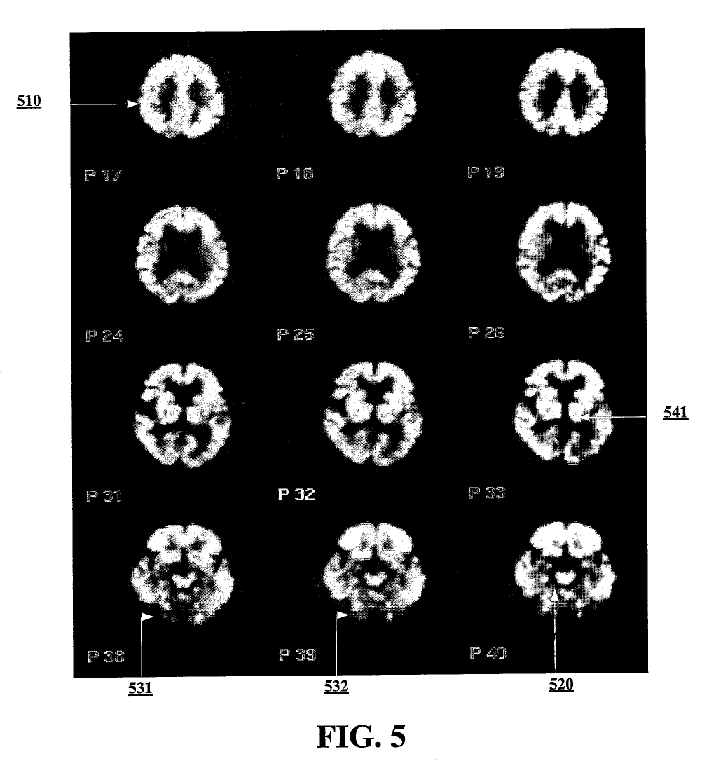

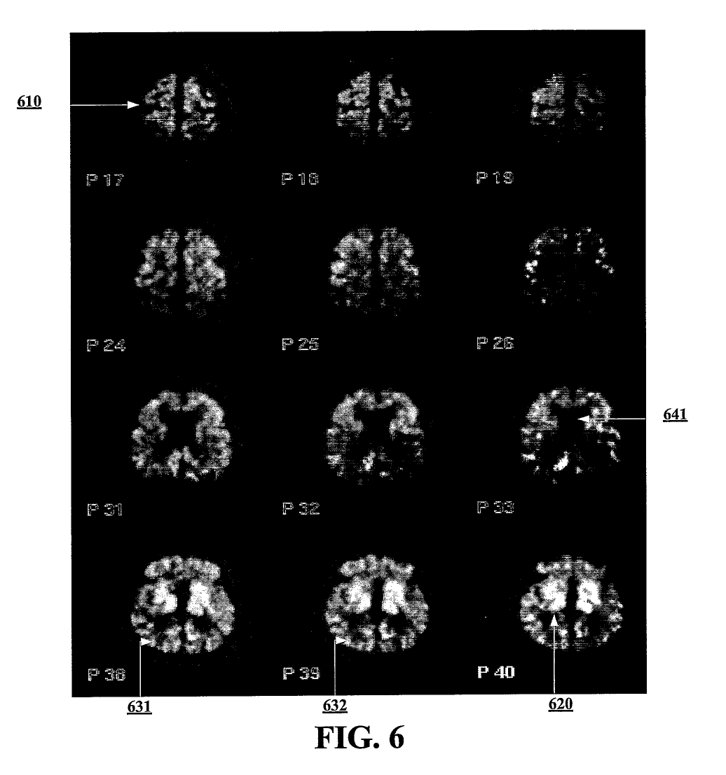

FIG. 5 is a selection of the resulting images obtained by applying the summation of the images through all the frames (i.e., summing each slice for all the frames) for the same Alzheimer's disease (AD) patient. FIG. 6 is a selection of the resulting images obtained by applying the summation of the images through all the frames for the same healthy volunteer. Summation (i.e., sum images) of the desired slices (planes) through the frames was also performed using the standard software of the PET device. Even though the summation of all the images through the frames generates nice-looking images with low noise, they have poor discrimination between the areas with different amyloid binding and also show a reduced difference between the AD patient and the healthy volunteer. In particular the contrast (discrimination) between the accumulation (i.e., kinetic activity) occurring, for example, in two particular locations in FIG. 5 in slice 38 531 and in slice 39 532 are not significantly different than the similar areas indicated in FIG. 6 in slice 38 631 and in slice 39 632 even though there is less noise in the images. The reduced contrast may also be shown between the AD patient and the healthy volunteer, for example shown by comparing slice 33 541, 641 in both FIGS. 5 and 6 which show less contrast than the contrast between FIG. 3 341 and FIG. 4 441.

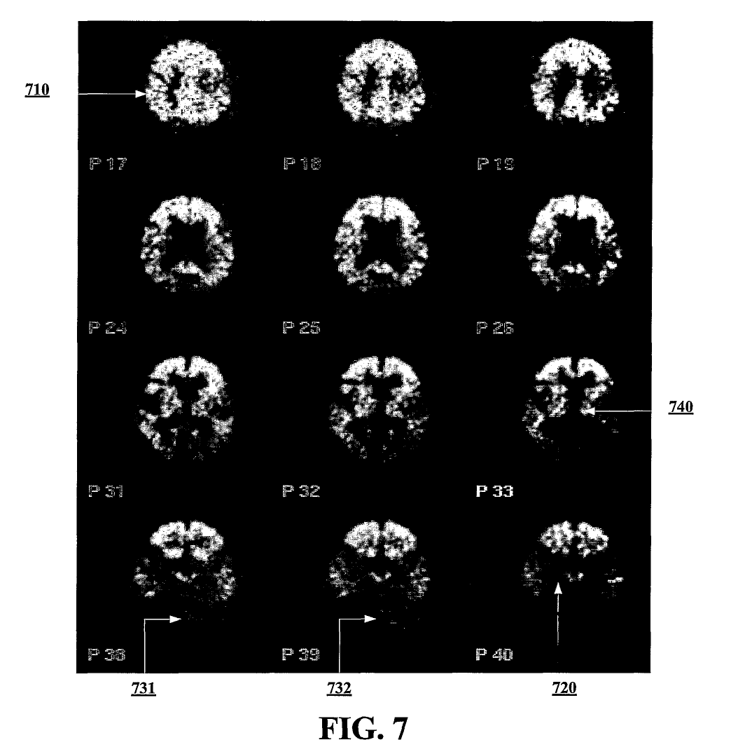

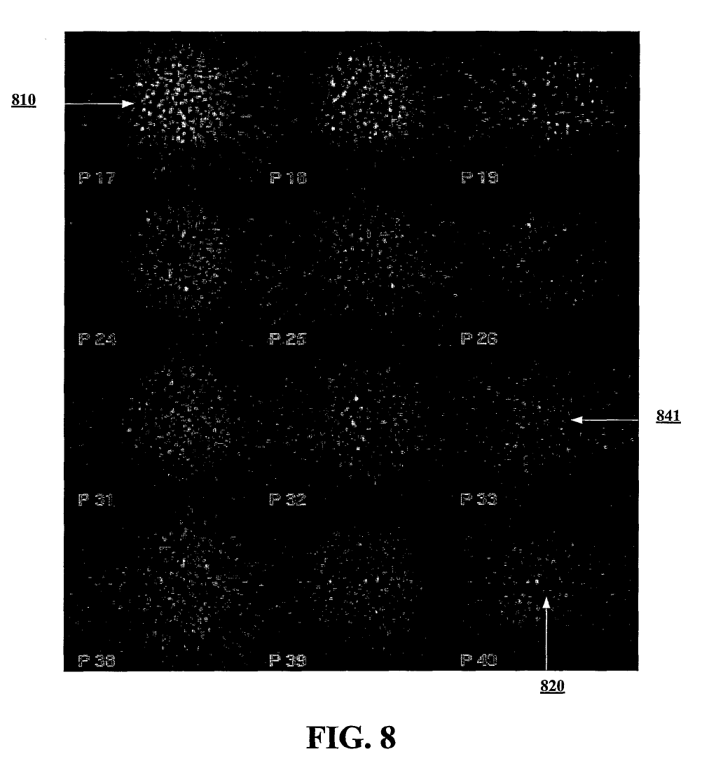

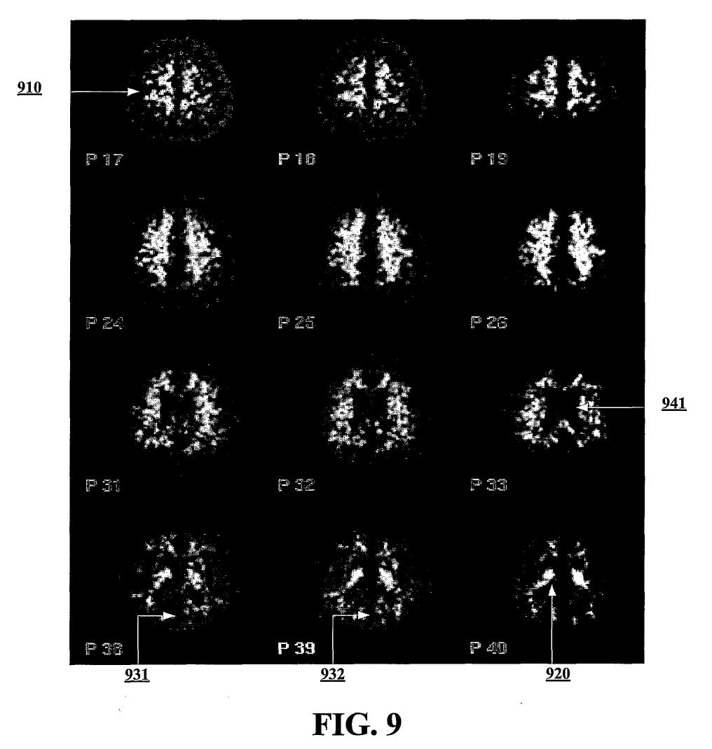

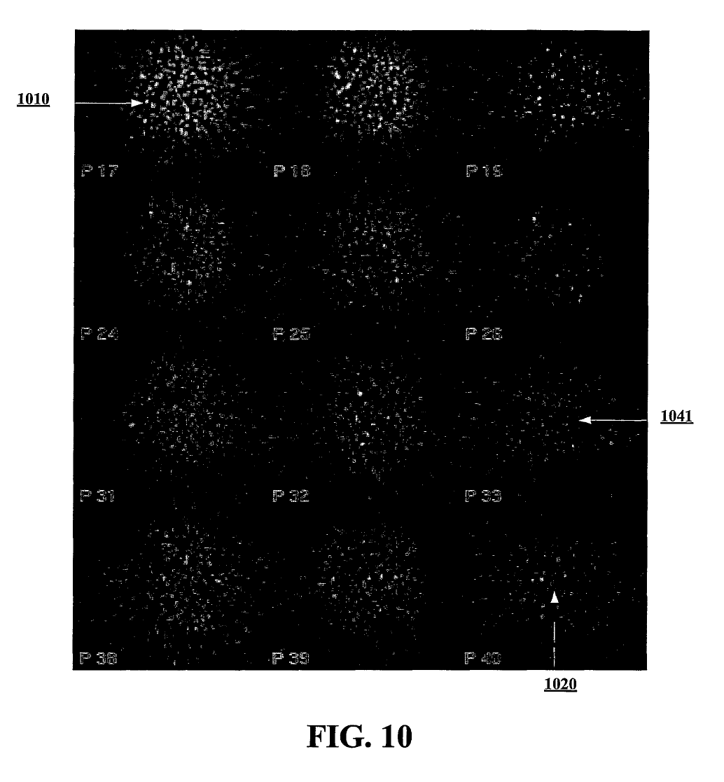

The following FIGS. 7-10 illustrate the application of PCA on the dynamic PET images after it is pre-normalized according to one embodiment of the present invention. FIG. 7 is a selection of the first principal component results (i.e., the PC1 images) of applying PCA on the pre-normalized dynamic PET images for the same Alzheimer's disease (AD) patient according to one embodiment of the present invention. FIG. 8 is a selection of the second principal component results (i.e., the PC2 images) of applying PCA on the pre-normalized dynamic PET images for the same Alzheimer's disease (AD) patient according to one embodiment of the present invention. FIG. 9 is a selection of the first principal component results (i.e., the PC1 images) of applying PCA on the pre-normalized dynamic PET images for the same healthy volunteer according to one embodiment of the present invention. FIG. 10 is a selection of the second principal component results (i.e., the PC2 images) of applying PCA on the pre-normalized dynamic PET images for the same healthy volunteer according to one embodiment of the present invention. The discrimination (i.e., contrast) between the PC1 images of the AD patient in FIG. 7 and the healthy volunteer in FIG. 9 can be shown in particular areas of amyloid binding indicating kinetic activity. In particular, in slice 38 731, 931 and in slice 39 732, 932 the contrast between the AD patient and the healthy volunteer is clearly more apparent than the contrast shown using summation in FIGS. 5 & 6 or in the contrast shown using the reference Patlak method in FIGS. 3 & 4. This contrast is also shown, for example, in slice 33 741, 941 of the PC1 images where the main features of the dynamic PET images are captured while slice 33 in the remaining higher components 841, 1041 contain mostly the remaining noise. In addition to the improved contrast, the PC1 images contain a low noise level as compared to the results obtained using either reference Patlak or summation (i.e., sum images).

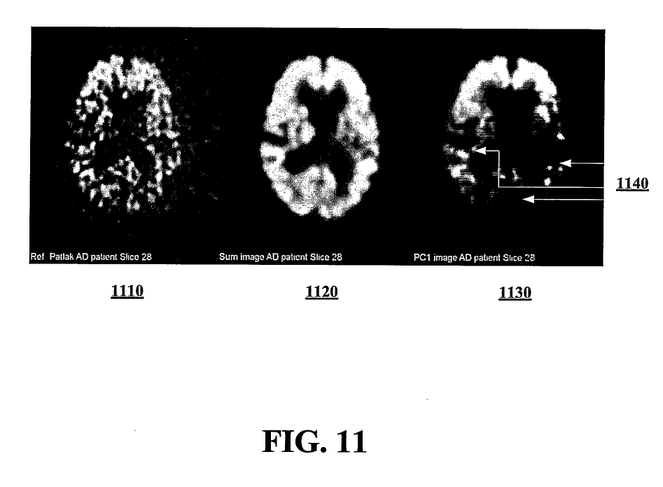

FIG. 11 is a comparison between the slice 28 images obtained for the same Alzheimer's disease (AD) patient using the reference Patlak method, the summation method, and PCA on pre-normalized dynamic PET images according to one embodiment of the present invention. The PC1 image 1130 obtained according one embodiment of the present invention has notably improved image quality over the summation method image 1120 and the reference Patlak image 1110. The areas of different amyloid binding 1140 are much more clearly visible (i.e., there is a greater contrast shown) helping in the visualization of the kinetic activity. The lack of noise in the PC1 image 1130 is also notable in comparison to the conventionally obtained images 1110, 1120.

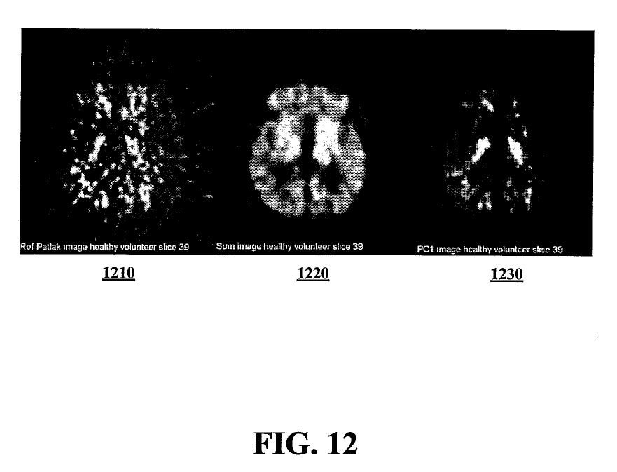

FIG. 12 is a comparison between the slice 39 images obtained for the same healthy volunteer using the reference Patlak method, the summation method, and PCA on pre-normalized dynamic PET images according to one embodiment of the present invention. The PC1 image 1230 of slice 39 for the healthy volunteer obtained according to one embodiment of the present invention also shows notably improved contrast and reduced noise over the summation method image 1220 and the reference Patlak image 1210.

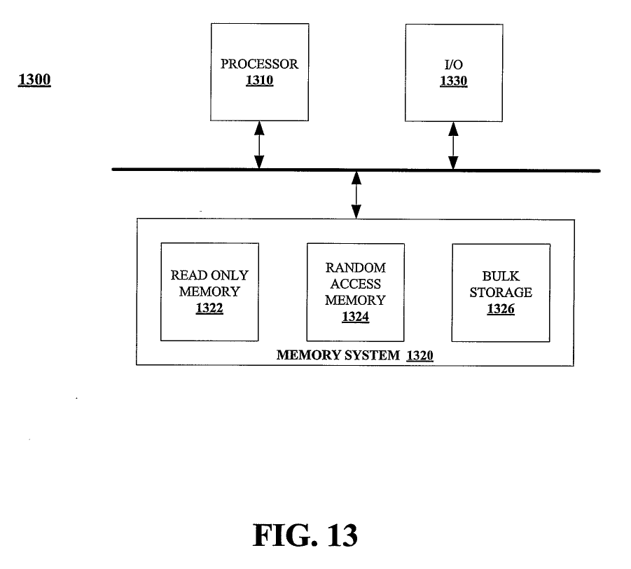

FIG. 13 is a block diagram illustrating the platform on which the SW-PCA method for applying PCA to dynamic PET images using pre-normalization techniques may operate according to one embodiment of the present invention. Functionality of the foregoing embodiments may be provided on various computer platforms executing program instructions. One such platform 1300 is illustrated in the simplified block diagram of FIG. 13. There, the platform 1300 is shown as being populated by a processor 1310, a memory system 1320 and an input/output (I/O) unit 1330. The processor 1310 may be any of a plurality of conventional processing systems, including microprocessors, digital signal processors and field programmable logic arrays. In some applications, it may be advantageous to provide multiple processors (not shown) in the platform 1300. The processor(s) 1310 execute program instructions stored in the memory system. The memory system 1320 may include any combination of conventional memory circuits, including electrical, magnetic or optical memory systems. As shown in FIG. 13, the memory system may include read only memories 1322, random access memories 1324 and bulk storage 1326. The memory system not only stores the program instructions representing the various methods described herein but also can store the data items on which these methods operate. The I/O unit 1330 would permit communication with external devices (not shown).

1. A method for improving quality in a positron emission tomography image, comprising:
correcting a negative pixel in the positron emission tomography image, wherein the negative pixel has a negative value and the correcting sets the negative pixel to a non-negative value;
normalizing a pixel in the new set of input data for the positron emission tomography image to correct for a background noise;
determining a reference region in the positron emission tomography image;
enhancing a contrast of the pixel in the new set of input data for the positron emission tomography image as a function of the reference region; and
applying a multivariate analysis method on the new set of input data for the positron emission tomography image.

2. The method according to claim 1, wherein the correcting step sets the negative pixel to the non-negative value equal to a square root of an absolute value of the negative value.

3. The method according to claim 1, the normalizing step further comprising:
normalizing a pixel in the new set of input data for the positron emission tomography image to correct for a background noise, wherein a value of the pixel is divided by a standard deviation of the background noise.

4. The method according to claim 1, wherein the reference region is determined as a function of outlining at least one region of interest for a biological/anatomical area being studied in the positron emission tomography image.

5. The method according to claim 1, the enhancing step further comprising:
enhancing a contrast of the pixel in the new set of input data for the positron emission tomography image as a function of the reference region, wherein enhancing of the contrast is a function of dividing a value of the pixel by a mean pixel value for the reference region.

6. The method according to claim 1, wherein the multivariate analysis method is a principal component analysis method.

7. A method for normalizing a pixel in a positron emission tomography image, comprising:
identifying a mask for a background area in the positron emission tomography image, wherein the background area includes a plurality of background pixels;
determining a standard deviation for the mask, wherein the standard deviation is determined as a function of the plurality background pixels;
dividing a value of a pixel in the positron emission tomography image by the standard deviation to determine a normalized value of the pixel; and
storing the normalized value of the pixel in a memory system.

8. The method according to claim 7, wherein the identifying step is performed manually by a user drawing the mask on the positron emission tomography image using a computer system.

9. The method according to claim 7, the dividing step further comprising:
dividing the value of the pixel in the positron emission tomography image by the standard deviation to determine the normalized value of the pixel where the value of the pixel is not equal to zero and setting the normalized value of the pixel equal to zero where the value of the pixel is equal to zero.

10. The method according to claim 7, the dividing step further comprising:
dividing the value of the pixel in the positron emission tomography image by the standard deviation to determine the normalized value of the pixel where the pixel is not located in the background area.

11. The method according to claim 7, the storing step further comprising:
storing the normalized value of the pixel in a column vector of a matrix in a memory system.

12. A method for enhancing a contrast of a pixel in a positron emission tomography image, comprising:
outlining a region of interest in the positron emission tomography image, wherein the region of interest includes at least one object pixel in a principal area being studied in the positron emission tomography image;
determining a reference region as a function of the outlined region of interest, wherein the reference region contains the object pixel;
calculating a mean value for the reference region as a function of the object pixel;
dividing a value of the pixel in the positron emission tomography image by the mean value to determine a normalized value of the pixel; and
storing the normalized value of the pixel in a memory system.

13. The method according to claim 12, wherein the outlining step is performed using a first principal component generated applying principal component analysis on the positron emission tomography image.

14. The method according to claim 13, wherein the outlining step is performed manually by a user drawing the region of interest on the first principal component using a computer system.

15. The method according to claim 14, further comprising:
exporting a set of coordinates for the reference region wherein the set of coordinates can be applied to any frame of a slice.
using a first principal component generated applying principal component analysis on the positron emission tomography image.

16. The method according to claim 12, the dividing step further comprising:
dividing the value of the pixel in the positron emission tomography image by the mean value to determine the normalized value of the pixel where the value of the pixel is not equal to zero and setting the normalized value of the pixel equal to zero where the value of the pixel is equal to zero.

17. The method according to claim 12, the storing step further comprising:
storing the normalized value of the pixel in a column vector of a matrix in a memory system.

18. A system for improving quality in a positron emission tomography image, comprising:
a memory system;
an input/output unit; and
a processor, wherein the processor is adapted to:
(i) correct a negative pixel in the positron emission tomography image, wherein the negative pixel has a negative value and the correcting sets the negative pixel to a non-negative value;
(ii) normalize a pixel in the new set of input data for the positron emission tomography image to correct for a background noise;
(iii) determine a reference region in the positron emission tomography image;
(iv) enhance a contrast of the pixel in the new set of input data for the positron emission tomography image as a function of the reference region; and
(v) apply a multivariate analysis method on the new set of input data for the positron emission tomography image.

19. A system according to claim 18, for normalizing a pixel in a positron emission tomography image, comprising:
a memory system;
an input/output unit; and
a processor, wherein the processor is adapted to:
(i) identify a mask for a background area in the positron emission tomography image, wherein the background area includes at least one background pixel and the background area does not include a principal area being studied in the positron emission tomography image;
(ii) determine a standard deviation for the mask, wherein the standard deviation is determined as a function of the at least one background pixel;
(iii) divide a value of a pixel in the positron emission tomography image by the standard deviation to determine a normalized value of the pixel; and
(iv) store the normalized value of the pixel in a memory system.

20. A system according to claim 18 for enhancing a contrast of a pixel in a positron emission tomography image, comprising:
a memory system;
an input/output unit; and
a processor, wherein the processor is adapted to:
(i) outline a region of interest in the positron emission tomography image, wherein the region of interest includes at least one object pixel in a principal area being studied in the positron emission tomography image;
(ii) determine a reference region as a function of the outlined region of interest, wherein the reference region contains the object pixel;
(iii) calculate a mean value for the reference region as a function of the object pixel;
(iv) divide a value of the pixel in the positron emission tomography image by the mean value to determine a normalized value of the pixel; and
(v) store the normalized value of the pixel in a memory system.

21. A computer readable medium including instructions adapted to execute a method for improving quality in a positron emission tomography image, the method comprising:
correcting a negative pixel in the positron emission tomography image, wherein the negative pixel has a negative value and the correcting sets the negative pixel to a non-negative value;
normalizing a pixel in the new set of input data for the positron emission tomography image to correct for a background noise;
determining a reference region in the positron emission tomography image;
enhancing a contrast of the pixel in the new set of input data for the positron emission tomography image as a function of the reference region; and
applying a multivariate analysis method on the new set of input data for the positron emission tomography image.

22. A computer readable medium according to claim 21, including instructions adapted to execute a method for normalizing a pixel in a positron emission tomography image, the method comprising:
identifying a mask for a background area in the positron emission tomography image, wherein the background area includes at least one background pixel and the background area does not include a principal area being studied in the positron emission tomography image;
determining a standard deviation for the mask, wherein the standard deviation is determined as a function of the at least one background pixel;
dividing a value of a pixel in the positron emission tomography image by the standard deviation to determine a normalized value of the pixel; and
storing the normalized value of the pixel in a memory system.

23. A computer readable medium according to claim 21 including instructions adapted to execute a method for enhancing a contrast of a pixel in a positron emission tomography image, the method comprising:
outlining a region of interest in the positron emission tomography image, wherein the region of interest includes at least one object pixel in a principal area being studied in the positron emission tomography image;
determining a reference region as a function of the outlined region of interest, wherein the reference region contains the object pixel;
calculating a mean value for the reference region as a function of the object pixel;
dividing a value of the pixel in the positron emission tomography image by the mean value to determine a normalized value of the pixel; and
storing the normalized value of the pixel in a memory system.
